(19) United States
(12) Patent Application Publication
(10) Pub. No.: US 2017/0267411 A1
(43) Pub. Date: Sep. 21, 2017

(54) OIL TANK

(71) Applicant: Rolls-Royce Deutschland Ltd & Co KG, Blankenfelde-Mahlow (DE)

(72) Inventors: Juergen BEIER, Schulzendorf (DE); Andrew PATERSON, Berlin (DE)

(21) Appl. No.: 15/457,040

(22) Filed: Mar. 13, 2017

(30) Foreign Application Priority Data
Mar. 21, 2016 (DE) 10 2016 105 229.9

(51) Int. Cl. B65D 25/56; F02C 7/06; G02B 27/02; F02C 3/04

(52) U.S. Cl. CPC B65D 25/56; F02C 3/04; F02C 7/06; G02B 27/025; F05D 2220/323

(57) ABSTRACT

An oil tank includes an outer wall with a side limitation and an interior enclosed by the outer wall. A view passage extending from the side limitation into the interior of the tank allows external visual reading of the oil fill level of the tank at or close to the tank center, where changes in the oil fill level caused by inclined positions of the tank are minimal. The view passage includes a beginning of the passage formed in the area of the side limitation that includes a first optically transparent window. An end of the passage includes a second optically transparent window. A passage wall extending between the beginning and end of the passage delimits the view passage against the interior of the tank.

### REFERENCE TO RELATED APPLICATION

This application claims priority to German Patent Application No. 10 2016 105 229.9 filed on Mar. 21, 2016, the entirety of which is incorporated by reference herein.

### BACKGROUND

The invention relates to an oil tank.

To determine the oil level inside an oil tank of an aircraft engine it is known to configure a viewing window in the outer wall of the oil tank. By means of such a viewing window, a maintenance engineer can directly perceive the oil level of an oil tank in a visual manner independently of the measurement values of an oil level sensor, and can determine whether the amount of oil that is present in the oil tank is sufficient for further operation.

However, when it comes to such a visual detection of the oil level, there is the problem that the visual indication is faulty if the oil tank is not in an exactly horizontal orientation, but rather in an inclined position, that is, if it is tilted about the longitudinal axis or transverse axis. This may for example be the case due to the unevenness of the ground. In order to compensate for such an incorrect indication, it is known to fill the oil tank with a larger amount of oil than is actually necessary. Typically, the oil tank of an aircraft engine contains approximately 1 liter of additional oil.

It is known from DE 2634919 C2 to arrange a sensor centrally inside the oil tank. Here, it is provided that the sensor is supplied with light by means of first fiber-optic light guides, and that the position of a float ball that is arranged inside the sensor is detected by means of second fiber-optic light guides. The first and second fiber-optic light guides are introduced into the tank from the outside.

There is a need to provide an oil tank, in particular an oil tank for an aircraft engine, which facilitates the exact visual detection of the filling level inside the oil tank even when the oil tank is in an inclined position.

### SUMMARY

According to an embodiment of the invention, an oil tank is provided that has an outer wall which comprises a side limitation as well as an interior of the tank which is enclosed by the outer wall. A view passage is provided which extends into the interior of the tank of the oil tank starting from the side limitation, and which allows to visually read from the outside the filling level of the oil tank that is filled with oil either in or close to the tank center. What is considered tank center within the meaning of the present invention is that site inside the oil tank in which changes in the filling level of the oil tank filled with oil that are caused due to inclined positions of the oil tank are minimal.

Thus, the present invention is based on the idea to provide a view line to the tank center by means of a view passage which makes it possible to visually detect the filling level of the oil tank either in or close to the tank center from the outside, for example with the eyes of a maintenance engineer. Since the filling level is detected in or close to the tank center, where changes in the filling level due to inclined positions of the oil tank either do not occur at all or are minimal, the filling level is thus detected in an exact manner.

Here, it is not necessary that the view passage extends so far into the interior of the tank that the filling level of the oil tank that is filled with oil is detected exactly in the tank center. A considerable reduction of an incorrect indication which is caused by inclined positions of the oil tank already occurs when the view passage extends so far into the interior of the tank that the filling level of the oil tank that is filled with oil can be detected close to the tank center. At that, the filling level is detected close to the tank center within the meaning of the present invention when the detected filling level is detected more precisely at an inclined position of the oil tank by at least the factor 3, in particular by at least the factor 5, in particular by at least the factor 10 than with a detection at a viewing window at the side limitation.

Thanks to the exact detection of the filling level of the oil tank, it is no longer necessary to take into account a possibly inclined position of the oil tank when determining the oil tank size and the tank volume. In particular, it is no longer necessary to add an additional amount of oil. Accordingly, a weight reduction can be achieved.

The view passage has a beginning of the passage which is formed in the area of the side limitation. At that, the beginning of the passage comprises a first optically transparent window. The first optically transparent window consists of an optically transparent material, for example glass or synthetic material. It can also be referred to as a viewing glass. The first optically transparent window is thus formed in or at an opening in the side limitation of the oil tank. It allows a maintenance engineer to look through the view passage from the outside in the direction of the tank center. The first optical window can be configured in a planar or curved manner.

It can be provided that the first optically transparent window is attached in a sealed and fire-proof manner in the side limitation of the oil tank, so that the integrity of the oil tank is not compromised by the view passage and its components.

What is referred to as a side limitation of the oil tank is any kind of structure that laterally delimits the oil tank when the latter is arranged horizontally. The side limitation can be formed by multiple straight side walls, for example when the oil tank has the shape of a cuboid, or can be formed by a curved side wall, for example when the oil tank has the shape of a cylinder. Apart from the side limitation, the oil tank also has a bottom and a cover lid, which are connected to the side limitation and, together with the same, form the outer wall of the oil tank.

The view passage further has an end of the passage which is embodied towards the tank center. Here, the end of the passage comprises a second optically transparent window. At the second optically transparent window, the filling level is indicated in or close to the tank center. Through the first optically transparent window, this filling level in or close to the tank center can be directly read. According to one embodiment of the invention, the second optical window is embodied in a planar manner. It can be a glass window or a window made of a synthetic material, for example.

A passage wall extends between the beginning of the passage and the end of the passage, delimiting and sealing the view passage against the interior of the tank. The passage wall consists of metal, for example. Principally, it can be made of any material. The passage can for example have a rectangular cross-section or a circular cross-section, i.e. the view passage can be formed as a round or a tetragonal tube, for example. The view passage that is delimited by the passage wall against the interior of the tank can be hollow in the sense that it is filled only with air or alternatively with another transparent gas.

According to an embodiment of the invention, the second optically transparent window is provided with a height scale such that the filling level in the tank center can be directly read at the second optically transparent window based on the scale.

In one embodiment of the invention, the view passage extends linearly between the beginning of the passage and the end of the passage, wherein a filling level height that is indicated at the second optically transparent window can be read through the first optically transparent window.

In another embodiment of the invention, an optical system is integrated into the view passage, optically mapping the second optically transparent window on the first optically transparent window. The integration of an optical sensor in the view passage allows to form the view passage with areas of different diameters and/or in a curved manner, for example.

Thus, it is provided in one embodiment of the invention that the optical sensor is embodied as a wide-angle lens. In one embodiment, such wide-angle lens is embodied as a fisheye lens. The wide-angle lens is located at the transition between a first area of the view passage which has a smaller cross-sectional surface and adjoins the beginning of the passage and a second area of the view passage which has an increasing cross-sectional surface and adjoins the end of the passage. In this manner, the volume of the view passage can be reduced in the first area of the view passage, so that it requires a smaller part of the internal volume of the oil tank, and the oil tank can accordingly take in more oil. By using a wide-angle lens, the filling level height that is indicated at the second optical window is mapped on the view passage despite the fact that the latter has a reduced cross-section where it adjoins the first optical window, and the filling level height can be visually detected there.

In one embodiment of the invention, the view passage extends starting from the side limitation through the interior of the tank in the direction of a tank center line of the oil tank. Here, the tank center line is a line that, in the horizontally oriented oil tank, extends vertically to the surface of the oil contained in the oil tank and that has at least one point in which the changes in the filling level of the oil tank filled with oil that are caused by inclined positions of the oil tank are minimal.

Here, the tank center line is defined with respect to the oil tank, i.e. it is an imagined line in the reference system of the oil tank. It is defined by a direction and at least one point it contains. The direction is the vertical direction in the horizontally oriented oil tank. If the oil tank is tilted, the tank center line is tilted, as well. The at least one point is the tank center in a regarded filling height, i.e. the point at which changes in the filling level that are caused by inclined positions of the oil tank are minimal in a regarded filling height.

Each filling level, i.e. each filling height of the oil tank, necessarily has a different tank center, since the vertical coordinate changes if the filling height is altered. Usually, the tank center line is the line that connects the tank centers of the oil tank in a horizontal orientation of the oil tank for different filling levels.

In one embodiment of the invention, it is provided that the view passage extends starting from the side limitation through the interior of the tank to the tank center line. In this manner, a particularly exact reading of the filling height is facilitated.

Further, it can be provided that the tank center line extends inside or in parallel to the plane of the second optically transparent window. In this manner, it is ensured that the second optically transparent window extends in the vertical direction across an area in which the filling level of the oil tank varies.

In principle, the present invention does not require any illumination of the second optically transparent window, since light falls into the view passage through the first optically transparent window, with this light illuminating the second optically transparent window. However, it can be provided in one embodiment variant of the invention that an additional illumination source is integrated into the view passage, illuminating the second optically transparent window. Here, the light of the additional illumination source is reflected by the second optically transparent window. The use of an additional illumination source can improve the reading quality in particular if light conditions are bad.

In principle, it is known to carry out a filling level detection by means of one or multiple sensors in addition to a visual detection of the filling level of an oil tank, with the sensors providing electrical signals regarding the filling level to an external unit. In one embodiment of the invention, it is provided that such a filling level sensor or digital sensor is arranged at the view passage in the area of the tank center. Here, too, the filling level sensor detects the filling level of the oil tank in an exact manner due to its position in the tank center. Since it is attached at the view passage, easy mounting and support of the sensor is facilitated.

According to one embodiment of the invention, the oil tank and the view passage are embodied in such a manner that the view passage can be inserted into the oil tank from the outside through an opening in the side limitation of the oil tank after the oil tank has been manufactured. At that, the view passage is fixated in a sealing and fire-proof manner at the side limitation. In this way, an easy manufacture of the oil tank together with the view passage is facilitated, since the view passage is made as a separate part that is connected to the oil tank after it has been manufactured.

According to one embodiment, the view passage is embodied with a rectangular or circular cross-section.

According to another embodiment of the invention, the view passage is filled with air. It is thus a hollow volume that is filled only with air and that extends between the first optically transparent window and the second optically transparent window. However, as has already been explained, it is also possible to integrate an optical lens system into the view passage. Alternatively, the view passage can be filled with a different gas or can consist of a transparent solid body.

In principle, the oil tank can have any shape. According to one embodiment of the invention, it can be configured in a symmetrical manner with respect to the extension of the side limitation, for example in a cylindrical or a cuboid manner.

The invention further relates to an aircraft engine with an oil tank according to the invention.

### BRIEF DESCRIPTION OF THE DRAWINGS

The invention will be explained in more detail on the basis of exemplary embodiments with reference to the accompanying drawings in which:

FIG. 1 shows a simplified schematic sectional view of an aircraft engine that is embodied as a double-flow jet engine and has an oil tank;

FIG. 2 shows a sectional view of an oil tank according to the state of the art;

FIG. 3 shows an exemplary embodiment of an oil tank in which a view passage that extends from the side limitation of the oil tank to the tank center is formed;

FIG. 4 shows an enlarged rendering of the view passage of FIG. 3;

FIG. 5 shows a first alternative embodiment of a view passage, wherein an illumination source is integrated into the view passage; and

FIG. 6 shows a second alternative embodiment of a view passage, wherein a wide-angle lens is integrated into the view passage.

### DETAILED DESCRIPTION

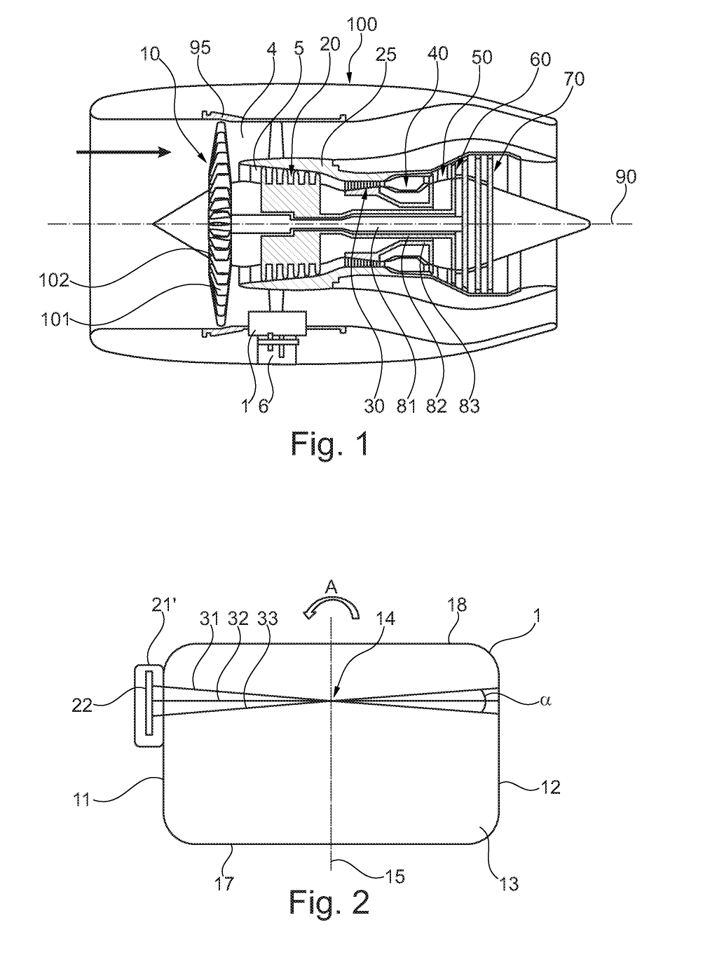

FIG. 1 schematically shows a double-flow jet engine 100, that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor stage and a stator stage. The jet engine 1 of FIG. 1 further has three separate shafts, a low-pressure shaft 81 which connects the low-pressure turbine 70 to the fan 10, a medium-pressure shaft 82 which connects the medium-pressure turbine 60 to the medium-pressure compressor 20, and a high-pressure shaft 83 which connects the high-pressure turbine 50 to the high-pressure compressor 30. However, this is to be understood to be merely an example. If, for example, the jet engine has no medium-pressure compressor and no medium-pressure turbine, only a low-pressure shaft and a high-pressure shaft would be present.

The fan 10 has a plurality of fan blades 101 that are connected to a fan disc 102. Here, the annulus of the fan disc 102 forms the radially inner delimitation of the flow path through the fan 10. Radially outside, the flow path is delimited by the fan housing 95. Upstream of the fan-disc 102, a nose cone is arranged.

Behind the fan 10, the jet engine 1 forms a secondary flow channel 4 and a primary flow channel 5. The primary flow channel 5 leads through the core engine which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 25 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or elements of the corresponding drive shaft connected to the hub.

The described components have a common symmetry axis 90. The symmetry axis 90 defines an axial direction of the aircraft engine. A radial direction of the aircraft engine extends perpendicularly to the axial direction.

The double-flow jet engine 100 further comprises an auxiliary device support 6 that drives a plurality of auxiliary devices in a mechanical manner, and an oil tank 1, which is typically a part of a closed recirculating oil system. The auxiliary device support 6 and the oil tank 1 are schematically shown in FIG. 1.

In the context of the present invention, the embodiment of the oil tank 1 is of particular importance, as will be explained in the following.

To provide a better understanding of the background of the present invention, first an oil tank 1 according to the state of the art is explained by referring to FIG. 2. The oil tank 1 has the shape of a cuboid and correspondingly an outer wall that comprises two side walls 11, 12, two further side walls that are not visible in the sectional view of FIG. 2, a ground surface 17, and a roof surface 18. The oil tank 1 defines an interior of the tank 13 that is filled with oil. At that, the four side walls form the side limitation of the oil tank 1.

In the one side wall 11 of the oil tank 1, a mounting support 21′ is arranged that has an optically transparent viewing window 22 that is attached in the side wall 11 in a sealed manner. The filling level of the oil in the oil tank 1 can be visually read from the outside at the viewing window 22. However, the filling level that is indicated at the viewing window 22 depends on the orientation of the oil tank 1. If the orientation of the oil tank 1 is exactly horizontal, the liquid surface 32 of the oil adjoining the side wall 11 and adjoining the side wall 12 have the same distance to the ground surface 17 and the roof surface 18. Accordingly, the filling level of the liquid surface 32 is correctly displayed at the viewing window 22.

If, on the other hand, the oil tank 1 is tilted, i.e. if it comes into an inclined position, a faulty filling level is read at the viewing window 22. Here, a tilting of the oil tank 1 can occur, for one thing, due to a tilting of the oil tank about its transverse axis (which is also referred to as pitching) and, for another thing, due to a tilting the oil tank about its longitudinal axis (which is also referred to as rolling). FIG. 2 shows the case where the tilting A occurs about the transverse axis. The reason for tilting may for example be an uneven ground surface on which the aircraft carrying the aircraft engine with the regarded oil tank is sitting.

It is assumed that the oil tank 1 can be tilted forward as well as backward by maximally the angle α/2 from its exactly horizontal position. Since the orientation of the liquid surface of the oil is not affected by a tilting of the oil tank 1, this leads to the liquid surface being oriented transversely in the reference system of the oil tank in the event that the oil tank 1 is tilted. This is illustrated in FIG. 2 by the liquid surfaces 31, 33. If the oil tank 1 is tilted forward by an angle α/2, what is present in the oil tank 1 is the liquid surface 31. If the oil tank 1 is tilted backward by an angle α/2, what is present in the oil tank 1 is the liquid surface 33. Accordingly, the viewing window 22 shows different and faulty filling levels in an inclined position of the oil tank 1.

At the same time, it follows from FIG. 2 that the filling level of the oil tank 1 in the tank center 14 is not affected by a tilting or by different inclined positions of the oil tank 1. The filling level height is substantially constant in the tank center 14. This is also true in the event that the oil tank is tilted about its longitudinal axis. When looking at both tilting possibilities of the oil tank, namely a tilting about the transverse axis and a tilting about the longitudinal axis, the tank center is a point in the interior of the tank.

FIG. 2 also shows a tank center line 15. The tank center line 15 is defined as the line that extends vertically with respect to the surface of the oil that is present inside the oil tank 1 in the horizontally oriented oil tank 1. At that, the tank center line 15 has at least one point in which changes in the filling level of the oil tank filled with oil which are caused by inclined positions of the oil tank are minimal, i.e. at least one tank center 14. Usually, the tank center line 15 is identical with the line that results when the tank centers for different filling heights of the oil tank 1 are arranged in a row. It is a straight line inside the oil tank 1.

Principally, it can also occur that the arrangement of the tank centers in a row does not form a straight line but a curved line. In particular, this can occur if the oil tank is configured in an asymmetrical manner. With the above definition of the tank center line, it is ensured that, also in that case, the tank center line is a straight line extending vertically with respect to the surface of the oil in the horizontally oriented oil tank 1.

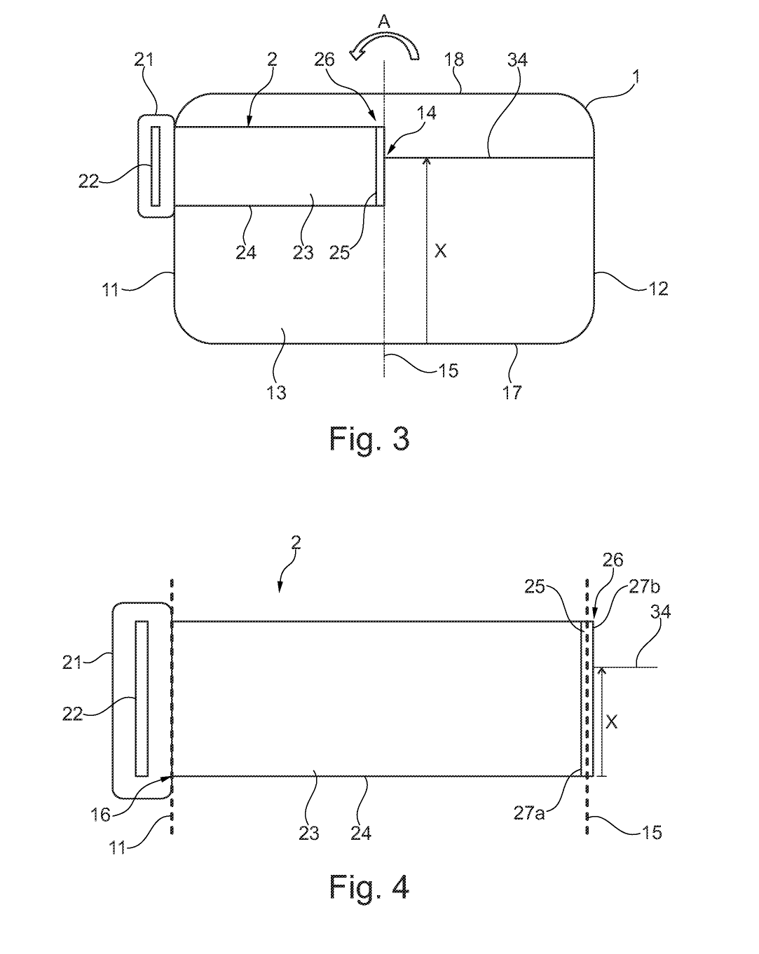

FIG. 3 shows an exemplary embodiment of an oil tank 1 according to the invention. The oil tank 1 has an outer wall that comprises four side walls, of which two side walls 11, 12 are shown, a ground surface 17, and a roof surface 18. Alternatively, the oil tank may have a cylindrical shape, in which case only one circular curved side wall is present. In principle, the oil tank 1 can have any shape. The liquid surface 34 indicates the actual filling level X of the oil tank 1 in the horizontally oriented oil tank 1. Due to the reasons that have been explained in connection to FIG. 2, the filling level X is indicated correctly on the tank center line 15 also in inclined positions of the oil tank.

It is provided in the present invention that a filling level averaging is carried out not at the side limitation of the oil tank but in the tank center 14, and that a view/sight passage 2 is provided for this purpose, facilitating an optical line of sight from the side limitation 11 of the oil tank 1 to the tank center 14 or the tank center line 15.

The view passage 2, which is shown in an enlarged manner in FIG. 4, comprises a beginning of the passage 21 that is formed in the area of the one side wall 11 and has a first optically transparent window 22. The beginning of the passage 21 with the viewing window 22 is attached at the side wall 11 by means of a fire-proof seal 16. At that, the side wall 11 has a recess (not separately shown) in the area of the view passage 2, through which the view passage 2 is inserted into the interior space of the oil tank 1, wherein the beginning of the passage 21 with the optically transparent window 22 closes off the recess in the side wall.

Connecting to the beginning of the passage 21 is a passage wall 24 that delimits the interior of the passage 23 from the interior of the tank 13. The passage wall 24 can be made of metal, for example. The interior of the passage 23 is hollow in the sense that it is filled only with air or alternatively with another transparent gas.

The passage wall 24 may for example have a rectangular or a circular cross-section. But even as the cross-sectional surface is constant across the length of the passage wall 24 in the shown exemplary embodiment, it does not necessarily have to be so.

The view passage 2 extends starting from the side limitation 11 through the interior of the tank 13 to the tank center 14, where it forms an end of the passage 26 with a second optically transparent window 25. Here, it can be provided that the end of the passage 26 has two front walls 27a, 27b which are arranged at a distance from each other and between which the second optically transparent window 25 is arranged. Both the first and the second optically transparent window 22, 25 are embodied in a planar manner in one embodiment of the invention.

The second optically transparent window 25 is arranged and oriented in such a manner that the tank center line 15, which is defined in the way as it has been explained in connection with FIG. 2, extends in the plane of the second optically transparent window 25. Thus, it is possible to read different filling levels X in the oil tank 1 directly at the second optically transparent window 25. For this purpose, it can be provided that the second optically transparent window 25 has a height scale from which the height of the filling level X can be directly read. Thus, the second optical window 25 is darker in the area that adjoins the oil than in the area that adjoins air. The dividing line 34 can be clearly seen at the second optical window 25.

The filling level X that is shown at the second optically transparent window 25 can be visually read from outside the oil tank 1 through the first optically transparent window 21 and the view passage 2. At that, the second optically transparent window 25 is illuminated with light that falls into the view passage 2 through the first optically transparent window 22. No separate illumination means are necessary.

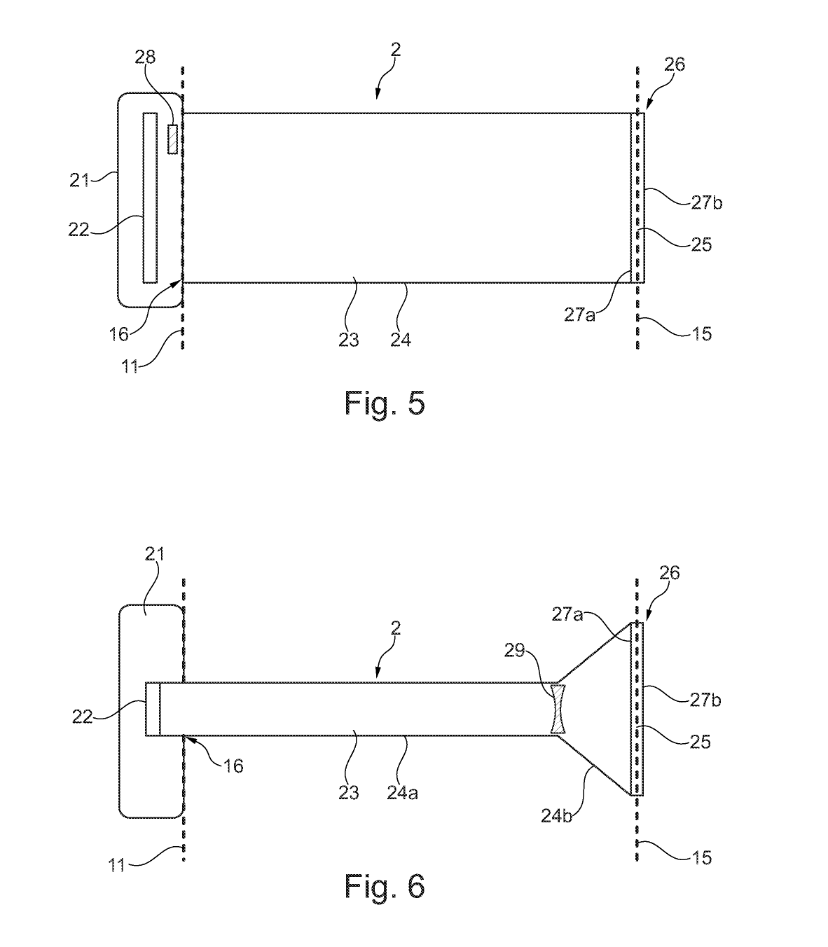

FIG. 5 shows an alternative exemplary embodiment, which differs from the exemplary embodiment of FIGS. 3 and 4 only in the fact that an illumination source 28 is additionally integrated into the view passage 2. The illumination source 28 illuminates the second optically transparent window 25 in addition to the light that falls into the view passage 2 through the first optically transparent window 22. In the shown exemplary embodiment, the illumination source 28 is located close to the viewing window 22. However, in principle it can be arranged at any location inside the view passage 2.

FIG. 6 shows another alternative exemplary embodiment. In the exemplary embodiment of FIG. 6, an optical system, namely a wide-angle lens 29, is integrated into the view passage 2. At that, the wide-angle lens 29 can be embodied as a fisheye lens. The wide-angle lens 29 is arranged in an area of the view passage 2 in which the cross-sectional surface of the view passage 2 varies. Thus, the view passage 2 comprises a first section 24a, in which the view passage 2 has a smaller and constant cross-sectional surface, and a second section 24b, in which the cross-sectional surface of the view passage continuously increases. For example, the cross-sectional surface increases in a funnel-shaped manner in section 24b. The wide-angle lens 29 is arranged at the transition between the two sections 24a, 24b.

Corresponding to the smaller cross-sectional surface of the view passage 2 in the section 24a that adjoins the first optically transparent window 22, the dimensions of the first optically transparent window 22 are also reduced.

Due to the wide-angle lens 29, the entire second optically transparent window 25 including the filling level it indicates can be mapped onto the smaller first optically transparent window 22, so that the filling level can again be visually read from the outside. At that, the second optically transparent window 25 is mapped in a scaled-down manner onto the first optically transparent window, so that a scaled-down rendering of the second optically transparent window 25 is visible. But this does not represent a problem if a scale is integrated into the second optically transparent window 25, so that the filling level can still be read directly. Alternatively, it would also be possible to integrate a scale that is adjusted to the image scale into the first optically transparent window 22.

The described embodiment of the view passage 2 makes it possible to reduce the internal volume 23 that forms the view passage 2 in the interior space of the oil tank, and in this way to increase the amount of oil that the oil tank can receive.

In a variation on the described exemplary embodiments, it can be provided that a digital sensor is additionally arranged at the view passage 2 in the area of the second transparent window 25, detecting the filling level of the oil tank by means of electric measurement values. By arranging such a digital sensor at the view passage 2, it can be ensured in a simple manner that the digital sensor is also arranged in that area of the oil tank in which changes in the filling level caused by inclined positions of the oil tank are minimal, namely in the tank center. At the same time, the attachment of such a digital sensor inside the oil tank can be carried out in a simple manner by means of the view passage 2.

The invention is not limited in its design to the exemplary embodiments described above, which are to be understood merely as examples. For instance, the view passage may have a different shape than has been described.

It is furthermore pointed out that the features of the individually described exemplary embodiments of the invention can be combined in various combinations with one another. Where areas are defined, they include all the values within these areas and all the sub-areas falling within an area.

What is claimed is:

1. An oil tank, comprising:
an outer wall that comprises a side limitation,
an interior of the tank that is enclosed by the outer wall, and
a view passage that extends starting from the side limitation into the interior of the tank of the oil tank and that makes it possible to visually read from the outside the filling level of the oil tank filled with oil in or close to the tank center, where changes in the filling level of the oil tank filled with oil which are caused by inclined positions of the oil tank are minimal,
wherein the view passage comprises:
a beginning of the passage that is formed in the area of the side limitation and that comprises a first optically transparent window,
an end of the passage that comprises a second optically transparent window, and
a passage wall that extends between the beginning of the passage and the end of the passage, and that delimits the view passage against the interior of the tank.

2. The oil tank according to claim 1, wherein the first optically transparent window is embodied in a fire-proof manner in the side limitation.

3. The oil tank according to claim 1, wherein the second optically transparent window is provided with a height scale.

4. The oil tank according to claim 1, wherein the passage wall is formed by a metal wall.

5. The oil tank according to claim 1, wherein the view passage extends in a linear manner between the beginning of the passage and the end of the passage, wherein a filling level height that is visible at the second optically transparent window can be read through the first optically transparent window.

6. The oil tank according to claim 1, wherein the view passage comprises an optical system that optically maps the second optically transparent window onto the first optically transparent window.

7. The oil tank according to claim 6, wherein the optical sensor is configured as a wide-angle lens and is it located at the transition between a first area of the view passage, which has a smaller cross-sectional surface, and a second area of the view passage, which has an increasing cross-sectional surface.

8. The oil tank according to claim 1, wherein the view passage extends starting from the side limitation through the interior of the tank in the direction of a tank center line of the oil tank, which, in the horizontally oriented oil tank, extends vertically with respect to the surface of the oil that is present in the oil tank, wherein the tank center line has at least one point at which changes in the filling level of the oil tank filled with oil that are caused by inclined positions of the oil tank are minimal.

9. The oil tank according to claim 8, wherein the view passage extends starting from the side limitation through the interior of the tank to the tank center line.

10. The oil tank according to claim 8, wherein the tank center line extends in or in parallel to the plane of the second optically transparent window.

11. The oil tank according to claim 1, wherein an illumination source is integrated in the view passage, illuminating the second optically transparent window.

12. The oil tank according to claim 1, wherein a digital sensor is arranged at the view passage towards the tank center, detecting the filling level height of the oil tank.

13. The oil tank according to claim 1, wherein the oil tank and the view passage are embodied in such a manner that the view passage can be inserted into the oil tank from the outside through an opening in the side limitation of the oil tank after the oil tank has been manufactured.

14. The oil tank according to claim 1, wherein the view passage has a rectangular or circular cross-section.

15. The oil tank according to claim 1, wherein the view passage is filled with air or another transparent gas.

16. An oil tank, comprising:
an outer wall that comprises a side limitation,
an interior of the tank that is enclosed by the outer wall, and
a view passage that extends starting from the side limitation into the interior of the tank of the oil tank and that makes it possible to visually read from the outside the filling level of the oil tank filled with oil in or close to the tank center, where changes in the filling level of the oil tank filled with oil which are caused by inclined positions of the oil tank are minimal,
wherein the view passage comprises:
a beginning of the passage that is formed in the area of the side limitation and that comprises a first optically transparent window,
an end of the passage that comprises a second optically transparent window, and
a passage wall that extends between the beginning of the passage and the end of the passage, and that delimits the view passage against the interior of the tank,
wherein the view passage is filled with air or another transparent gas, and
the view passage extends in a linear manner between the beginning of the passage and the end of the passage.

17. An oil tank, comprising:
an outer wall that comprises a side limitation,
an interior of the tank that is enclosed by the outer wall, and
a view passage that extends starting from the side limitation into the interior of the tank of the oil tank and that makes it possible to visually read from the outside the filling level of the oil tank filled with oil in or close to the tank center, where changes in the filling level of the oil tank filled with oil which are caused by inclined positions of the oil tank are minimal,
wherein the view passage comprises:
a beginning of the passage that is formed in the area of the side limitation and that comprises a first optically transparent window,
an end of the passage that comprises a second optically transparent window, and
a passage wall that extends between the beginning of the passage and the end of the passage, and that delimits the view passage against the interior of the tank,
wherein the view passage extends starting from the side limitation through the interior of the tank to the tank center line of the oil tank, wherein, in the horizontally oriented oil tank, the tank center line extends vertically with respect to the surface of the oil that is present in the oil tank and has at least one point at which changes in the filling level of the oil tank filled with oil which are caused by inclined positions of the oil tank are minimal.

18. The oil tank according to claim 17, wherein the tank center line extends in or in parallel to the plane of the second optically transparent window.

19. The oil tank according to claim 17, wherein the view passage extends in a linear manner between the beginning of the passage and the end of the passage.

20. The aircraft engine with an oil tank according to claim 1.
